(19) United States
(12) Patent Application Publication
(10) Pub. No.: US 2013/0219201 A1
(43) Pub. Date: Aug. 22, 2013

(54) ELECTRONIC DEVICE SYSTEMS AND METHODS FOR MAINTAINING LOW POWER CONSUMPTION WHILE PROVIDING POSITIONING FUNCTION IN ELECTRONIC DEVICE SYSTEM

(71) Applicants: Zhang LUO, Beijing (CN); Qiu-Huan ZHAO, Hebei (CN)

(72) Inventors: Zhang LUO, Beijing (CN); Qiu-Huan ZHAO, Hebei (CN)

(73) Assignee: MEDIATEK SINGAPORE PTE. LTD., Singapore (SG)

(21) Appl. No.: 13/553,058

(22) Filed: Jul. 19, 2012

(30) Foreign Application Priority Data
Feb. 22, 2012 (CN) 201210042913.0

(51) Int. Cl. G06F 1/00

(52) U.S. Cl. 713/323

(57) ABSTRACT

An electronic device system includes a first device and a second device. The first device controls system operations and operates in at least a normal mode and a sleep mode having lower power consumption. After issuing a condition setting signal carrying at least a wake up condition, the first device switches from the normal mode to the sleep mode. After receiving an interrupt indication signal, the first device switches from the sleep mode to the normal mode. The second device is coupled to the first device and continuously receives and processes multiple satellite signals to obtain position information. The second device receives the condition setting signal from the first device and determines whether the wake up condition has been met according to the position information. When the wake up condition has been met, the second device issues the interrupt indication signal.

### CROSS REFERENCE TO RELATED APPLICATIONS

This Application claims priority of China Patent Application No. 201210042913.0, filed on Feb. 22, 2012, the entirety of which is incorporated by reference herein.

### BACKGROUND OF THE INVENTION

1. Field of the Invention

The invention relates to a positioning system, and more particularly to a low power consumption positioning system.

2. Description of the Related Art

Electronic applications and products to improve the quality of life have become more and more popular. Within the various kinds of electronic device products, there are some products which integrate multiple functionalities together so as to improve the convenience for users.

For example, cellular phones, tablet computers, or other electronic devices integrating the functionalities of global positioning, short distance data transmission and long distance data transmission . . . etc. together have become more and more popular.

However, as the amount of functionalities provided by an electronic device increases, the power consumption of the electronic device increases, accordingly. Therefore, a low power consumption electronic device and method for extending life span of the battery equipped in the electronic device is highly required.

### BRIEF SUMMARY OF THE INVENTION

Electronic device systems and methods for maintaining low power consumption while providing a positioning function in an electronic device system are provided. An exemplary embodiment of an electronic device system comprises a first device and a second device. The first device controls system operations and operates in at least a normal mode and a sleep mode having lower power consumption than the normal mode. After issuing a condition setting signal carrying at least a wake up condition, the first device switches from the normal mode to the sleep mode, and after receiving an interrupt indication signal, the first device switches from the sleep mode to the normal mode. The second device is coupled to the first device and continuously receives and processes a plurality of satellite signals to obtain position information. The second device receives the condition setting signal from the first device and determines whether the wake up condition has been met according to the position information. When the wake up condition has been met, the second device issues the interrupt indication signal.

An exemplary embodiment of a method for maintaining low power consumption while providing a positioning function in an electronic device system comprises: issuing a condition setting signal carrying at least a wake up condition by a first device, wherein after issuing the condition setting signal, the first device enters a sleep mode having low power consumption; receiving the condition setting signal by a second device; continuously receiving and processing a plurality of satellite signals to obtain position information by the second device; determining whether the wake up condition has been met according to the position information by the second device; and issuing an interrupt indication signal to wake up the first device by the second device when the wake up condition has been met.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a block diagram of an electronic device system according to an embodiment of the invention;

FIG. 2 is a schematic diagram showing a concept of determining whether a wake up condition has been met according to an embodiment of the invention;

FIG. 3 is a schematic diagram showing another concept of determining whether a wake up condition has been met according to another embodiment of the invention;

FIG. 4 is a schematic diagram showing yet another concept of determining whether a wake up condition has been met according to yet another embodiment of the invention;

FIG. 5 is a schematic diagram showing yet another concept of determining whether a wake up condition has been met according to yet another embodiment of the invention; and

FIG. 6 is a flow chart of a method for maintaining low power consumption while providing a positioning function in an electronic device system according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

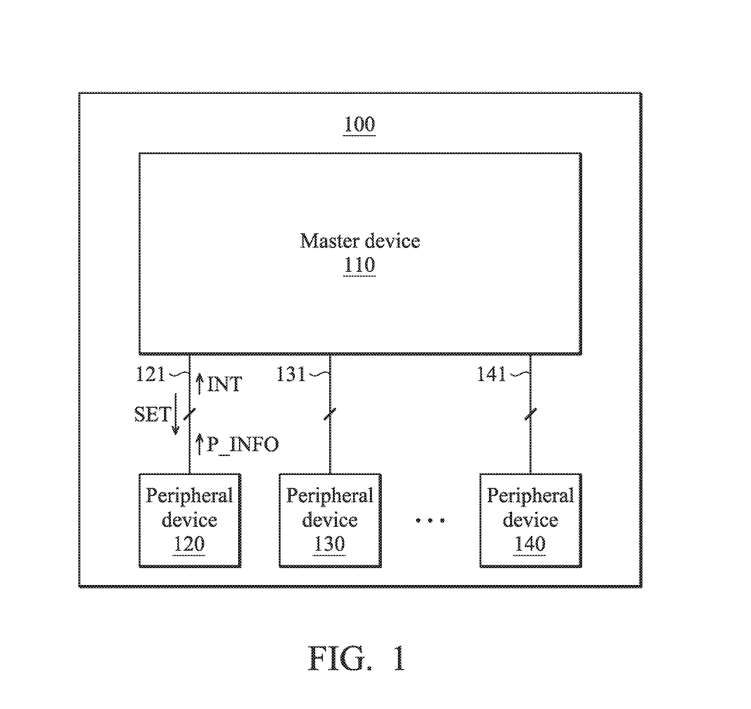

FIG. 1 is a block diagram of an electronic device system according to an embodiment of the invention. The electronic device system 100 may comprise a plurality of devices 110, 120, 130 and 140, wherein the device 110 may be a master device in the system for controlling system operations and devices 120, 130 and 140 may be the peripheral devices in the system for providing supplementary functions. The master device 110 and the peripheral devices 120, 130 and 140 may be coupled to each other through the corresponding communication interfaces 121, 131 and 141 connected therebetween for transmitting control signals and data.

For example, the master device 110 may be an application processor of a portable electronic device (such as a cellular phone, personal digital assistance, or any portable or handheld electronic devices) or a computer device (such as a personal computer, a tablet computer, or any portable computer devices), and may comprise at least a central processing unit, a storage medium and a plurality of hardware resources and software modules. The master device 110 may manage the hardware resources and software modules of the electronic device system 100 according to a set of operation system functions or a set of predetermined platform management functions, and may interact with the peripheral devices for controlling the system operations. The peripheral devices 120, 130 and 140 may be chips or modules for providing different supplementary functions. For example, the peripheral devices 120, 130 and 140 may be a Global Position System (GSP) receiver chip or GPS receiver module, WiFi chip or WiFi module, LCD chip or LCD module, Bluetooth chip or Bluetooth module, or others.

Note that although there are three peripheral devices shown in FIG. 1, the invention should not be limited thereto. The invention concept may be implemented in any electronic device system comprising more than three or less than three peripheral devices. In addition, note that in the embodiments of the invention, the master device 110 and peripheral devices 120, 130 and 140 may be implemented as separate chips, or the master device 110 and one or more of the peripheral devices 120, 130 and 140 may be integrated in one chip, and the invention should not be limited to any of them.

According to an embodiment of the invention, the master device 110 may operate in at least a normal mode and a sleep mode having lower power consumption than the normal mode. When the master device 110 operates in the sleep mode, the system clock may be stopped. Therefore, the master device 110 basically does not function to achieve the best power saving result. In a preferred embodiment of the invention, one of the peripheral devices 120, 130 and 140 may be the device having the positioning function. For example, the peripheral device 120 may be the above-mentioned GSP receiver chip or GSP receiver module for receiving and processing satellite signals to obtain position information, while another one may be a display device having the display function. For example, the peripheral device 130 may be the above-mentioned LCD chip or LCD module for displaying the position information in real-time or displaying other system information. When a user needs the GSP function for a long period and also hopes the electronic device system 100 to consume as less power as possible, the user may activate a low power consumption positioning mechanism so that the electronic device system 100 may operate in a power saving mode and still maintain the positioning capability. The proposed low power consumption positioning mechanism will be illustrated in more detail in the following paragraphs.

According to an embodiment of the invention, when the electronic device system 100 and/or the master device 110 operate in the normal mode, the user may enter or set up some wake up conditions through the user interface of the electronic device system 100. After receiving information regarding the wake up conditions entered or set up by the user, the master device 110 may generate and issue a condition setting signal SET carrying the wake up condition(s) to the peripheral device 120. After issuing the condition setting signal SET (or, in other embodiments, when the master device 100 receives at least an acknowledge signal responded by the peripheral device 120), the master device 110 may switch from the normal mode to the sleep mode. As the master device 110 enters the sleep mode, the peripheral device 130 may be notified and enter the sleep mode, too. When the peripheral device 130 has entered the sleep mode, the peripheral device 130 may not display the position information.

Although the master device 110 has entered the sleep mode, the peripheral device 120 may still operate in the background so as to obtain the position information in real-time. After obtaining the position information, the peripheral device 120 may determine whether the wake up condition set by the master device 110 is met according to the position information. When the wake up condition has been met, the peripheral device 120 may issue the interrupt indication signal INT to wake up the master device 110. After issuing the interrupt indication signal INT, the peripheral device 120 may further transmit the currently obtained position information P_INFO to the master device 110.

According to an embodiment of the invention, the communication interface 121 between the master device 110 and the peripheral device 120 may comprise one or more hardware devices, such as the General Purpose I/O (GPIO), the Universal Asynchronous Receiver/Transmitter (UART), or others, for transmitting or receiving the condition setting signal SET, the interrupt indication signal INT and the position information P_INFO. After receiving the interrupt indication signal INT, the master device 110 may switch from the sleep mode to the normal mode. After receiving the position information P_INFO, the master device 110 may further direct the peripheral device 130 to display the current position information.

According to another embodiment of the invention, the master device 110 and the peripheral device 130 may again enter the sleep mode to save the battery power after displaying the position information for a predetermined period. In the embodiments of the invention, because the low power consumption positioning mechanism is activated, the master device 110 and/or the peripheral device 130 may be awake only when the wake up condition has been met, so that the electronic device system 100 can have the best power saving performance.

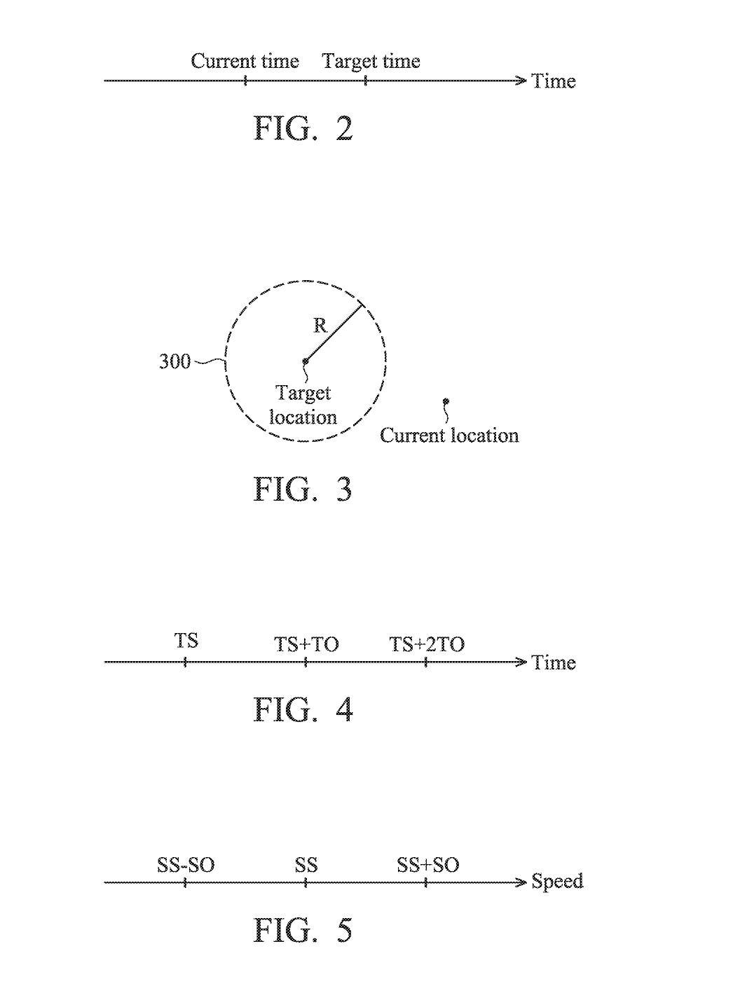

According to the embodiments of the invention, the wake up condition may be the target time, target speed, target altitude, target location, target value, or any combination thereof, or others. For example, in an embodiment of the invention, when the wake up condition is the target time, the peripheral device 120 may obtain a current time from the currently obtained position information (or obtain by other ways, such as from the master device 110). When the current time achieves the target time, the peripheral device 120 may issue the interrupt indication signal INT. FIG. 2 is a schematic diagram showing a concept of determining whether the wake up condition has been met according to an embodiment of the invention.

According to another embodiment of the invention, when the wake up condition is the target speed, the peripheral device 120 may estimate a current speed according to the currently obtained position information. For example, the peripheral device 120 may obtain the longitude and latitude of the current location of the electronic device system 100 according to the satellite signals and estimate a moving speed of the electronic device system 100 according to the amount of change in the longitude and latitude per unit time. When the current speed achieves the target speed, the peripheral device 120 may issue the interrupt indication signal INT. Note that in the embodiment of the invention, the term “achieve” used here may have different meanings according to different system designs. For example, when the current speed has increased to exceed the target speed, when the current speed has decreased to become less than the target speed, when the current speed equals to or exceeds the target speed, and when the current speed exceeds or is less than the target speed plus or minus a predetermined value, or others, may mean “achieve”.

According to yet another embodiment of the invention, when the wake up condition is the target altitude, the peripheral device 120 may estimate a current altitude according to the currently obtained position information. When the current altitude achieves the target altitude, the peripheral device 120 may issue the interrupt indication signal INT. Note that, similarly, the term “achieve” used here may have different meanings according to different system designs. For example, when the current altitude has increased to exceed the target altitude, when the current altitude has decreased to become less than the target altitude, when the current altitude equals to or exceeds the target altitude, when the current altitude exceeds or is less than the target altitude plus or minus a predetermined value, or others, may all mean “achieve”.

According to yet another embodiment of the invention, when the wake up condition is the target location, the peripheral device 120 may estimate a current location according to the currently obtained position information. For example, the peripheral device 120 may obtain the current location according to the current longitude and latitude of the electronic device system 100. When the current location achieves the target location, the peripheral device 120 may issue the interrupt indication signal INT. Note that, similarly, the term “achieve” used here may have different meanings according to different system designs. For example, when the current location is close to the target location, when the current location is the target location, when the current location is inside of a predefined region centered by the target location, or others may mean “achieve”.

FIG. 3 is a schematic diagram showing another concept of determining whether a wake up condition has been met according to another embodiment of the invention, where R represents a predetermined distance. In the embodiment, when the current location is inside of the predetermined region 300 centered by the target location, the peripheral device 120 may issue the interrupt indication signal INT. In this embodiment, since the user is close to the target location, the peripheral device 130 may keep displaying the position information in real-time for the user.

According to yet another embodiment of the invention, the wake up condition may also comprise a start value and an offset. For example, a start time and a time offset, a start speed and a speed offset, a start altitude and an altitude offset, a start location and a distance offset, or any combination thereof, or others. The peripheral device 120 may comprise an adder or a subtractor, or any other unit that can perform addition or subtraction operations.

FIG. 4 is a schematic diagram showing yet another concept of determining whether a wake up condition has been met according to yet another embodiment of the invention. In the embodiment, the wake up condition comprises a start time TS and a time offset TO. Every time when the current time obtained by the peripheral device 120 equals to a result of the start time TS plus or minus a multiple of the time offset TO, the peripheral device 120 issues the interrupt indication signal INT. As shown in FIG. 4, every time when the current time equals to time TS, (TS+TO), (TS+2T0) . . . etc., the peripheral device 120 issues the interrupt indication signal INT.

FIG. 5 is a schematic diagram showing yet another concept of determining whether a wake up condition has been met according to yet another embodiment of the invention. In this embodiment, the wake up condition may comprise a start speed SS and a speed offset SO. Every time when the current speed obtained by the peripheral device 120 equals to a result of the start speed SS plus or minus a multiple of the speed offset SO, the peripheral device 120 issues the interrupt indication signal INT. As shown in FIG. 5, every time when the current speed equals to speed (SS−SO), SS, (SS+SO) . . . etc., the peripheral device 120 issues the interrupt indication signal INT.

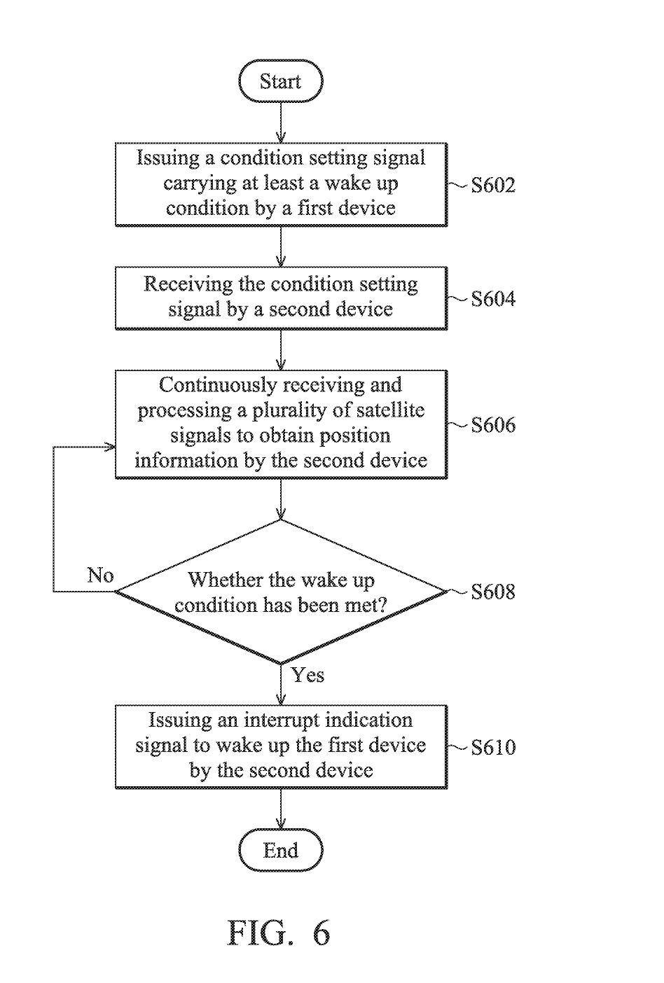

FIG. 6 is a flow chart of a method for maintaining low power consumption while providing a positioning function in an electronic device system according to an embodiment of the invention. First, a condition setting signal carrying at least a wake up condition is issued by a first device (Step S602). After issuing the condition setting signal, the first device enters a sleep mode having low power consumption. Next, the condition setting signal is received by a second device (Step S604). Next, a plurality of satellite signals are continuously received and processed by the second device to obtain position information (Step S606). Finally, whether the wake up condition has been met is determined by the second device according to the position information (Step S608). When the wake up condition has been met, an interrupt indication signal to wake up the first device is issued by the second device (Step S610). When the wake up condition has not been met, the flow goes back to step S606 for the second device to continuously receive and process the satellite signals so as to obtain the latest position information.

Based on the proposed low power consumption positioning mechanism, maximum power saving performance of the electronic device system may be achieved when the user activates the low power consumption positioning mechanism or when the master device and/or other device (such as the display device) actively enters the sleep mode. Even if the mater device stops functioning, the electronic device system may still obtain the latest position information so that the position accuracy will not be degraded due to stopping of the functioning of the master device.

The above-described embodiments of the present invention can be implemented in any of numerous ways. For example, the embodiments may be implemented using hardware, software or a combination thereof. It should be appreciated that any component or collection of components that perform the functions described above can be generically considered as one or more processors that control the above discussed function. The one or more processors can be implemented in numerous ways, such as with dedicated hardware, or with general purpose hardware that is programmed using microcode or software to perform the functions recited above.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An electronic device system, comprising:
a first device, controlling system operations, wherein the first device operates in at least a normal mode and a sleep mode having lower power consumption than the normal mode, and after issuing a condition setting signal carrying at least a wake up condition, the first device switches from the normal mode to the sleep mode, and after receiving an interrupt indication signal, the first device switches from the sleep mode to the normal mode; and
a second device, coupled to the first device and continuously receiving and processing a plurality of satellite signals to obtain position information, wherein the second device receives the condition setting signal from the first device and determines whether the wake up condition has been met according to the position information, and when the wake up condition has been met, the second device issues the interrupt indication signal.

2. The electronic device system as claimed in claim 1, wherein the first device and the second device are separate chips.

3. The electronic device system as claimed in claim 1, wherein the first device and the second device are integrated in one chip.

4. The electronic device system as claimed in claim 1, further comprising a third device coupled to the first device for displaying the position information in real-time, wherein when the first device has entered the sleep mode, the third device does not display the position information.

5. The electronic device system as claimed in claim 4, wherein after issuing the interrupt indication signal, the second device further transmits the position information to the first device, and the first device directs the third device to display the position information.

6. The electronic device system as claimed in claim 1, wherein the wake up condition comprises a target speed and the second device estimates a current speed according to the position information, and when the current speed achieves the target speed, the second device issues the interrupt indication signal.

7. The electronic device system as claimed in claim 1, wherein the wake up condition comprises a target altitude and the second device estimates a current altitude according to the position information, and when the current altitude achieves the target altitude, the second device issues the interrupt indication signal.

8. The electronic device system as claimed in claim 1, wherein the wake up condition comprises a target location and the second device estimates a current location according to the position information, and when the current location achieves the target location, the second device issues the interrupt indication signal.

9. The electronic device system as claimed in claim 1, wherein the wake up condition comprises a target time and the second device obtains a current time according to the position information, and when the current time achieves the target time, the second device issues the interrupt indication signal.

10. The electronic device system as claimed in claim 1, wherein the wake up condition comprises a start value and an offset and the second device estimates a current value according to the position information, and whenever the current value achieves a result of the start value plus or minus a multiple of the offset, the second device issues the interrupt indication signal.

11. A method for maintaining low power consumption while providing a positioning function in an electronic device system, comprising:
issuing a condition setting signal carrying at least a wake up condition by a first device, wherein after issuing the condition setting signal, the first device enters a sleep mode having low power consumption;
receiving the condition setting signal by a second device;
continuously receiving and processing a plurality of satellite signals to obtain position information by the second device;
determining whether the wake up condition has been met according to the position information by the second device; and
issuing an interrupt indication signal to wake up the first device by the second device when the wake up condition has been met.

12. The method as claimed in claim 11, further comprising:
displaying the position information in real-time by a third device, wherein when the first device has entered the sleep mode, the third device does not display the position information.

13. The method as claimed in claim 12, further comprising:
transmitting the position information to the first device by the second device after issuing the interrupt indication signal; and
directing the third device to display the position information by the first device.

14. The method as claimed in claim 11, wherein the wake up condition comprises a target speed, and the method further comprises:
estimating a current speed according to the position information by the second device; and
when the current speed achieves the target speed, issuing the interrupt indication signal by the second device.

15. The method as claimed in claim 11, wherein the wake up condition comprises a target altitude, and the method further comprises:
estimating a current altitude according to the position information by the second device; and
when the current altitude achieves the target altitude, issuing the interrupt indication signal by the second device.

16. The method as claimed in claim 11, wherein the wake up condition comprises a target location, and the method further comprises:
estimating a current location according to the position information by the second device; and
when the current location achieves the target location, issuing the interrupt indication signal by the second device.

17. The method as claimed in claim 11, wherein the wake up condition comprises a target time, and the method further comprises:
obtaining a current time by the second device; and
when the current time achieves the target time, issuing the interrupt indication signal by the second device.

18. The method as claimed in claim 11, wherein the wake up condition comprises a start value and an offset, and the method further comprises:
estimating a current value according to the position information by the second device; and
whenever the current value achieves a result of the start value plus or minus a multiple of the offset, issuing the interrupt indication signal by the second device.
